(19) United States
(12) Patent Application Publication
(10) Pub. No.: US 2003/0009508 A1
(43) Pub. Date: Jan. 9, 2003

(54) Method and system for providing processor task scheduling

(76) Inventors: Terry A. Troia, Roanoke, VA (US); Kenneth W. Boggs, Roanoke, VA (US); Patrick J. Conroy, Roanoke, VA (US); Jeffrey A. Melius, Roanoke, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/681,913

(22) Filed: Jun. 26, 2001

(51) Int. Cl. G06F 9/00

(52) U.S. Cl. 709/107

(57) ABSTRACT

In accordance with some embodiments of the method and system of the invention, tasks are scheduled in an operating system. Task information relating to tasks processed in the operating system is obtained. A graphical user interface is generated based on the obtained task information. Loading of the operating system is determined based on the graphical user interface. Further, the scheduling of tasks may be adjusted by a user based on the loading of the operating system.

### BACKGROUND OF THE INVENTION

The invention is directed to a method and system for monitoring and controlling the scheduling of tasks in an operating system.

Many processing systems utilize multitasking techniques. In the multitasking, preemptive scheduling environment of high performance digital controllers, for example, it is often difficult to verify that application tasks meet their target deadlines. Leveling the load of a central processing unit (CPU) can enhance performance by reducing tasks scheduling jitter and latency. Leveling the load can also increase idle time, which may be beneficial to ensure that tasks are completed by their target deadlines.

Traditionally, engineers have predicted loading based on the amount of code generated. However, for example, off-line projections of loading based on counting execution cycles are misleading at best. Such off-line projections of loading are often inaccurate due to the non-deterministic nature of modern memory caching, instruction pipelining and parallel instruction execution. Likewise, current modeling techniques do not accurately simulate task preemption or the random nature of external communication interrupts.

Also, it is known in the art to utilize time slice overrun counters. The addition of time slice overrun counters supplies an online indication of system health, but does not provide enough resolution to pinpoint a problem. As a result, utilizing conventional technology, engineers employ their experience, trial and error, and the gross idle time value to design a particular application.

### BRIEF SUMMARY OF THE INVENTION

It would be desirable to provide a robust, real time system to provide the ability to effectively monitor and control load leveling in an operating system. It would further be desirable to provide a method and system to automatically measure task execution time and scheduling. It would further be desirable to provide a method and system that offer an intuitive presentation of the information relevant to load leveling and an efficient technique for effecting changes in the load leveling of a processor.

The present invention overcomes the disadvantages of known methods and systems, and achieves additional advantages, by providing a method and system to effectively monitor and control loading performance in an operating system.

In accordance with some embodiments of the method and system of the invention, tasks are scheduled in an operating system. Task information relating to tasks processed in the operating system is obtained. A graphical user interface is generated based on the obtained task information. Loading of the operating system is determined based on the graphical user interface. Further, the scheduling of tasks may be adjusted based on the loading of the operating system.

### BRIEF DESCRIPTION OF DRAWINGS

The present invention can be more fully understood by reading the following detailed description of presently-preferred embodiments together with the accompanying drawings, in which like reference indicators are used to designate like elements, and in which:

FIG. 1 is a block diagram showing the relationship between a control systems tool and a controller device in accordance with one embodiment of the method and system of the invention;

FIG. 2 is a block diagram showing the control systems tool of FIG. 1 in further detail in accordance with one embodiment of the method and system of the invention;

FIG. 3 is a block diagram showing the user interface generation portion of FIG. 2 in further detail in accordance with one embodiment of the method and system of the invention;

FIG. 4 is a high-level flow chart showing an implementation of the profiling process in accordance with one embodiment of the method and system of the invention;

FIG. 5 is a diagram showing scheduling charts in accordance with one embodiment of the method and system of the invention;

FIG. 6 is a user interface illustrating aspects of the controller load profiler in accordance with one embodiment of the method and system of the invention;

FIG. 7 is a diagram showing a controller load window user interface to monitor chart and time slice information in accordance with one embodiment of the method and system of the invention;

FIG. 8 is a diagram showing a task window user interface to monitor the tasks and other information in a particular chart and time slice in accordance with one embodiment of the method and system of the invention;

FIG. 9 is a diagram showing a tool window user interface displaying various window titles in accordance with one embodiment of the method and system of the invention;

FIG. 10 is a diagram showing a controller properties dialog box in accordance with one embodiment of the method and system of the invention;

FIG. 11 is a block diagram illustrating the network system and controller data flow in accordance with one embodiment of the method of the invention;

FIG. 12 is a diagram showing controller code profiler data structure in accordance with one embodiment of the method and system of the invention;

FIG. 13 is a high-level flow chart showing a program implementation of a start configuration of the profiler in accordance with one embodiment of the method of the invention;

FIG. 14 is a high-level flow chart showing a program implementation of a start tool connection process in accordance with one embodiment of the method of the invention;

FIG. 15 is a high-level flow chart showing an implementation of the scheduling process in accordance with one embodiment of the method and system of the invention;

FIG. 16 is a flow chart showing in further detail the “perform scheduling interrupt service routine” step of FIG. 15 in accordance with one embodiment of the method and system of the invention;

FIG. 17 is a flow chart showing in further detail the “perform chart scheduling process” of FIG. 15 in accordance with one embodiment of the method and system of the invention;

FIG. 18 is a flow chart showing in further detail the “process the first chart in the frame” step of FIG. 17 in accordance with one embodiment of the method and system of the invention;

FIG. 19 is a flow chart showing in further detail the “process the task” step of FIG. 17 in accordance with one embodiment of the method and system of the invention;

FIG. 20 is a flow chart showing in further detail the “perform task calculations” step of FIG. 17 in accordance with one embodiment of the method and system of the invention;

FIG. 21 is a flow chart showing in further detail the perform frame calculations step of FIG. 17 in accordance with one embodiment of the method and system of the invention;

FIG. 22 is a scheduling screen shot showing a module definition in accordance with one embodiment of the method and system of the invention; and

FIG. 23 is a scheduling screen shot showing a task definition in accordance with one embodiment of the method and system of the invention.

### DETAILED DESCRIPTION OF THE INVENTION

In the method and system of the invention, a performance monitoring technique is provided. A user is able to monitor and control the processing of tasks in an operating system. As a result, the user is able to diagnose loading problems in an operating system more quickly and accurately and adjust the load to cure the loading problems.

In conventional techniques, the process of diagnosing processor loading problems was often performed utilizing trial and error techniques and was very inaccurate. However, in accordance with some embodiments of the method and system of the invention, a user is able to monitor operating system performance through a graphical user interface. Task scheduling and run times of tasks are graphically displayed. As a result, a user is able to quickly ascertain what task or tasks is contributing to operating system performance degradation. Task scheduling and task run time is easily adjustable from a user interface.

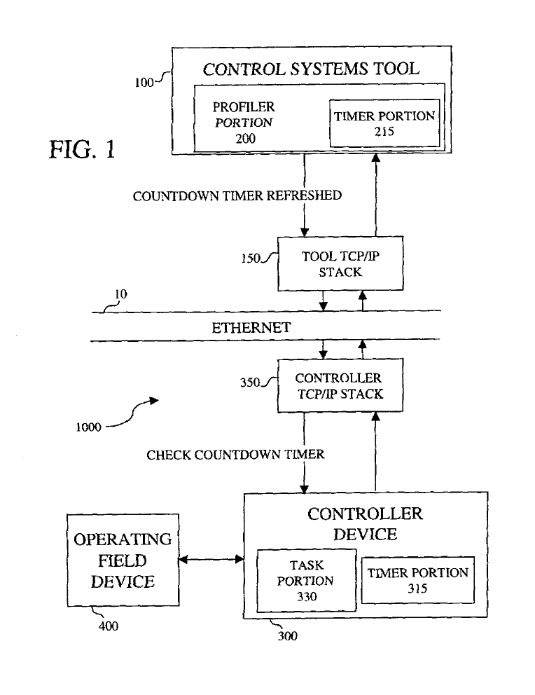

FIG. 1 is a block diagram showing one illustrative embodiment in accordance with one embodiment of the system and method of the invention. Specifically, FIG. 1 illustrates a network system 1000. The network system 1000 includes a control systems tool 100, a controller device 300 and an operating field device 400. The control systems tool 100 and the controller device 300 are connected to each other over an Ethernet 10. A human user interacts with the control systems tool 100 to monitor and control operations in the controller device 300. In turn, the controller device 300 controls an operating field device 400. For example, the operating field device may be a gas or hydrodynamic power generation device. Further, while an Ethernet is illustrated, it should be appreciated that any suitable communication network may be used to allow communication between the control systems tool 100 and the controller device 300.

As shown in FIG. 1, the control systems tool 100 includes a profiler portion 200. The profiler portion 200 includes a timer portion 215. The control systems tool 100 is connected to the Ethernet 10 utilizing a tool TCP/IP stack 150. As shown in FIG. 1, the control systems tool 100 monitors and refreshes a count-down timer. As is described in further detail below, the count-down timer provides a status indication of communication between the control systems tool 100 and the controller device 300.

The controller device 300 is connected to the Ethernet 10 utilizing a controller TCP/IP stack 350. As shown in FIG. 1, the controller device 300 includes a timer portion 315. The timer portion 315 monitors the status of a count-down time, working with the timer portion 215.

As shown in FIG. 1, the controller device 300 is connected to an operating field device 400. The controller device 300 may communicate with the operating field device 400 in any suitable manner, such as direct connection, utilizing a LAN or over the Internet.

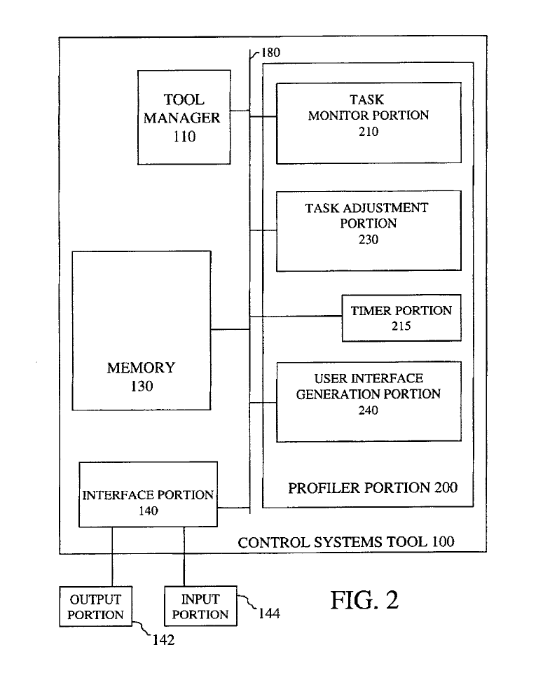

FIG. 2 is a block diagram illustrating further aspects of the control systems tool 100. The control systems tool 100 includes a tool manager portion 110. The tool manager portion 110 controls and monitors the overall operations of the control system tool 100. The control systems tool 100 also includes a memory 130. The memory 130 is a memory store for general use by the control systems tool 100 and may be used to contain programs or database information, for example. As is described above, the control systems tool 100 also includes an interface portion 140. The interface portion 140 is connected to an output portion 142 and an input portion 144. The output portion 142 and the input portion 144 interface with the tool TCP/IP stack 150 as shown in FIG. 1. As shown in FIG. 2, the tool manager portion 110, the memory 130, the interface portion 140, and the profiler portion 200 are all connected and communicate with each other utilizing a data link 180. For example, the data link 180 may be in the form of a databus between the components.

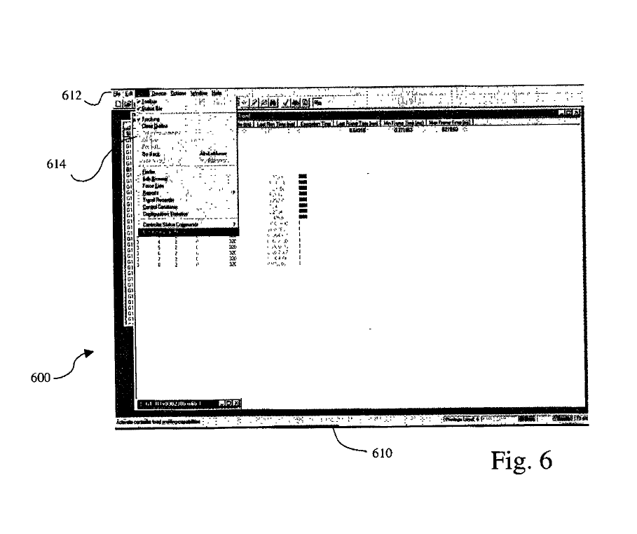

The control systems tool 100 further contains the profiler portion 200. As described below, the profiler portion 200 provides various task load profiling in accordance with some embodiments of the method and system of the invention. As shown in FIG. 2, the profiler portion 200 includes a task monitor portion 210, a task adjustment portion 230, the timer portion 215, and a user interface generation portion 240. The task monitor portion 210 interfaces with the controller device 300 to monitor tasks performed in the controller device 300. The task adjustment portion 230 in the control systems tool 100 adjusts various parameters of tasks performed in the controller device 300. Further, the user interface generation portion 240 interfaces with a human operator. For example, the use interface generation portion 240 generates the user interfaces shown in FIGS. 6-10, which are described below.

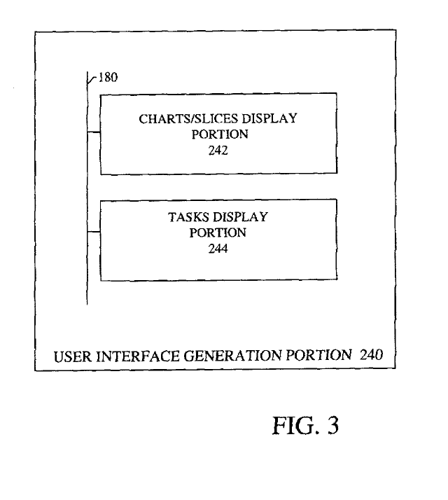

FIG. 3 shows the user interface generation portion 240 in further detail. The user interface generation portion 240 includes a task display portion 244 and a charts/time slices display portion 242. The task display portion 244 generates various graphical information, i.e., in the form of columned numbers or bar graphs, for example, regarding tasks performed in the controller device 300. The charts/time slices display portion 242 also displays information regarding tasks performed in the controller device 300, but more specifically displays information regarding charts and time slices.

As shown in FIG. 1, the control systems tool 100 includes a timer portion 215. Also, the controller device 300 includes a timer portion 315. The timer portion 215 and the timer portion 315 cooperate to monitor the status of communication between the control systems tool 100 and the controller device 300. Specifically, the timer portion 215 increments a countdown timer, i.e., refreshes the countdown timer. The countdown timer is checked by the timer portion 315. If the countdown timer reaches some pre-determined value, e.g., a value of zero, this condition indicates a termination of communication between the control systems tool 100 and the controller device 300. As a result, the controller device 300 will terminate certain operations. Specifically, for example, the controller device 300 will terminate acquisition of certain data and forwarding that data to the control systems tool 100.

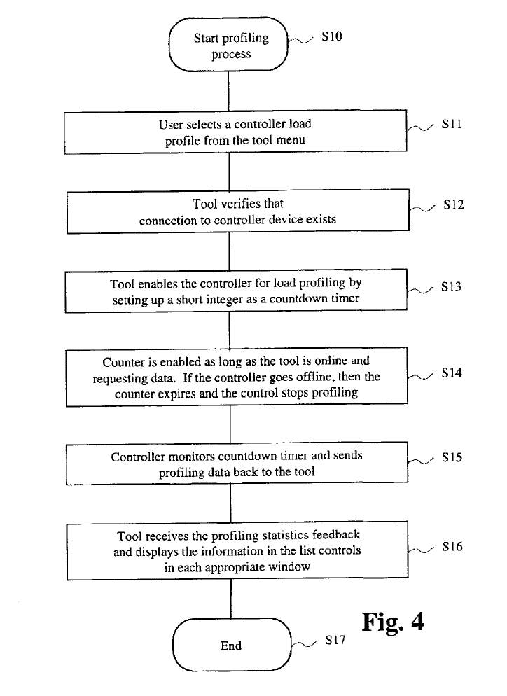

FIG. 4 is a high level flow chart showing further aspects of operation of the network system 1000. As shown in FIG. 2, the profiling process in accordance with some embodiments of the method and system of the invention is started in step S10. Then, the process passes to step S11. In step S11, a human user at the control systems tool 100 selects a controller load profile from a menu of tools. Once the user of the control systems tool 100 selects the controller load profile from the tool menu, the tool will verify that communication exists between the control systems tool 100 and the controller device 300. For example, an SDI (session data interface) connection may be utilized between the control systems tool 100 and the controller device 300. Accordingly, in step S12, the control systems tool 100 verifies that the SDI connection exists.

Once confirmation of connection is established, the control systems tool 100 enables the controller device 300 for load profiling by setting up a short integer value as a countdown timer, as is described above, and shown in step S13. The controller device 300 is enabled as long as the controller device 300 is in communication with control systems tool 100. In other words, the counter is enabling as long as the control systems tool 100 is on-line and requesting data from the controller device 300. If the controller device 300 goes off-line from the control systems tool 100, then the counter, as monitored by the timer portion 315 will expire based on some pre-determined countdown duration. Once the counter expires, then the controller device 300 stops profiling the various tasks being performed by the controller device 300.

Accordingly, so long as the countdown timer does not expire, the controller device 300 continues to send profiling data back to the control systems tool 100 while monitoring the countdown timer, as is illustrated in step S15. After step S15, the process passes to step S16.

As shown in step S16, the control systems tool 100 receives the profiling statistics feedback from the controller device 300. The control systems tool 100 displays the profiling statistics information utilizing the user interface generation portion 240.

As shown in step S17 of FIG. 4, the profiling process is terminated. The profiling process may be terminated upon the termination of communication from the control systems tool 100 and the controller device 300. Such termination of communication will result in the countdown timer expiring and the controller device 300 becoming disabled. Alternatively, the user may of course actively terminate the collection of profiling information.

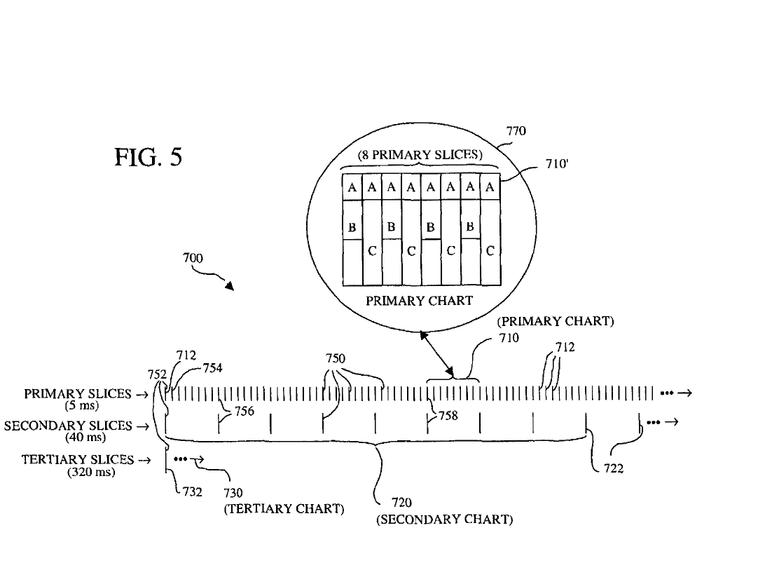

In its operations including controlling the operating field device 400, the controller device 300 performs a wide variety of tasks. Some tasks have a high priority, while other tasks have a low priority. Also, some tasks are lengthy, while other tasks are very brief. FIG. 5 is a diagram showing a task chart 700, which is utilized by the control systems tool 100 and the controller device controller device 300. In accordance with one embodiment of the method of the invention, the task chart 700 includes three subcharts.

Specifically, the task chart 700, as shown in FIG. 5 includes a plurality of primary charts 710, a secondary chart 720 and a portion of a tertiary chart 730. Each of the charts includes eight primary time slices 722. As shown in FIG. 5, each primary time slice 712 represents a time duration of 5 milli-seconds (ms). The secondary chart 720 includes eight secondary time slices 722. Each secondary time slice 722 represents a time duration of 40 ms. Further, the tertiary chart 730 includes eight tertiary time slices 732. Each tertiary time slice 732 represents a time duration of 320 ms. Thus, in the time that it takes for the controller device 300 to process the secondary chart, the primary chart is processed eight times. Further, in the time that it takes for the controller device 300 to process the tertiary chart, the primary chart is processed sixty-four times. As should be appreciated, only a portion of the tertiary time slice 732 is shown in FIG. 5, i.e., approximately one-eighth of a tertiary time slice 732. As shown in FIG. 5, “ticks” are the marks used to graphically represent the time slices.

Accordingly, the task chart 700 is a scheduling construct that partitions a set of time slices (712, 722, 732) into three groups. The designation of a particular task to a chart, i.e., the primary chart 710, the secondary chart 720, or the tertiary chart 730, assigns a task priority. In accordance with one embodiment of the method and system of the invention, a task assigned to the primary chart has priority over a task assigned to the secondary chart. Further, a task assigned to the secondary chart has priority over a task assigned to the tertiary chart.

It should be appreciated that time in the task scheduler 200 is broken into 512 equal frames 750. Each frame includes a primary time slice. A frame may include a secondary time slice. That is, as shown in FIG. 5, the first, eighth and sixteenth frames, for example, include a secondary time slice. Also, the first frame 752 includes a tertiary time slice 732. The execution of a frame 750 involves the execution of all tasks in all charts, i.e. the primary chart 710, the secondary chart 720, and the tertiary chart 730, scheduled in that particular frame.

As described above, the task chart 700 is broken into and includes 512 equal frames 750. Once the 512 equal frames in the task chart are completed, the controller device 300 repeats the processing of the task chart 700, subject to any modification of the task processing by the user. Tasks are placed for execution in a particular frame and chart depending on their scheduling period, order and priority. The primary chart 710, the secondary chart 720, and the tertiary chart 730 provide a construct to display the task information in a convenient manner.

However, it should be appreciated that the invention is not limited to the task chart 700 as shown in FIG. 5. For example, all the tasks in the primary chart, secondary chart and tertiary chart could be simply represented in a single long chart. However, such a long chart would not provide the convenience in representation of tasks that is provided by the task chart 700. This is especially true with tasks having a high occurrence. Such high occurrence tasks can easily be represented in the primary chart 710 of FIG. 5.

Further, it should be appreciated that the chart construct is not limited to that shown in FIG. 5. For example, rather the three charts of FIG. 5, another chart construct might be used. The other chart construct might include four separate charts possessing 4 ms, 32 ms, 256 ms, and 2048 ms time slices. Each of the four charts might include eight time slices.

With further reference to FIG. 5, the task chart 700 includes the primary time slices 722, the secondary time slices 722, and the tertiary time slices 732. As characterized herein, to process a task chart 700 means to process each of the frames 750 within that task chart 700. A primary chart 710 includes 8 primary time slices 712. Accordingly, to process a task chart 700 means that the primary chart 710, i.e. the tasks assigned to the primary chart, is processed 64 times, that is, 64 times 8 equals 512.

Additionally, processing the entirety of the task chart 700 means processing all the secondary time slices 722 in the secondary chart 720. As described above, each chart (710, 720, 730) includes 8 time slices. As shown in FIG. 5, the secondary time slices 722 are 40 ms in duration. Accordingly, one secondary time slice 722 in the secondary chart 720 is processed, i.e., the tasks contained therein are processed, while an entire primary chart 710 is processed. Thus, while 64 primary charts 710 are processed, only 8 secondary charts 720 are processed. It should thus be appreciated that the processing of one task chart 700 involves the processing of 8 secondary charts 720.

Similarly, as shown in FIG. 5, a tertiary time slice 732 is 320 ms in duration. Accordingly, during the processing of one tertiary time slice, 8 secondary charts 720 are processed. It should thus be appreciated that the processing of the task chart 700 involves the processing of only tertiary chart 730.

As characterized in accordance with one embodiment of the method of the invention described above, the processing of a frame 750 necessarily involves the processing of a primary time slice 722. However, the processing of a given frame may or may not involve the processing of a secondary time slice 722 and/or a tertiary time slice 732. To explain further, the frames 750 in FIG. 5 include illustrative frame 752, frame 754, frame 756 and frame 758, for example. As shown in FIG. 5, the processing of frame 752, the first frame, involves each of a primary time slice 712, a secondary time slice 722, and a tertiary time slice 732. Subsequent to processing of frame 752, the controller device 300 processes frame 754. However, the processing of frame 754 does not involve the processing of a secondary time slice 722 or a tertiary time slice 732, but rather only the processing of a primary time slice 722. However, it is possible that a task that occurred in the tertiary chart in frame 752 is not yet completed upon initiating the processing of frame 754. This results in a frame overrun, but not a chart overrun, as described below.

Further, the controller device 300 will ultimately process frame 756. As can be seen in FIG. 5, the processing of frame 756 involves repeating the processing of the primary chart 710. The processing of frame 756 also includes the processing of a secondary time slice 722, but not a tertiary time slice 732. Further, it should be appreciated that a complete secondary chart 720, i.e. including 8 secondary time slices 722, is processed prior to the processing of a further tertiary time slice 732. In this manner, binary scheduling is effected.

The processing time allocated to each frame 750 is a predetermined duration, i.e., “a frame period.” The frame period is dictated by a specification to the scheduler clock in the controller device 300. The choice of time slices in which tasks can be scheduled is limited to multiples of the frame period supported by a particular controller device 300.

Each chart (710, 720 or 730) can schedule a task in time slices that are 1, 2, 4 or 8 multiples of its base. Accordingly, as used herein, a base scheduling period is a smallest increment of time that a chart (710, 720 or 730) can schedule a task. Thus, the base scheduling period for the primary chart 710 is 5 ms. The base scheduling period for the secondary chart 720 is 40 ms. Further, the base scheduling period for the tertiary chart 730 is 320 ms.

Accordingly, the 5 ms primary chart 710 can schedule tasks periodically from 5 to 40 ms. Further, the 40 ms secondary chart 720 can schedule tasks periodically from 40 to 320 ms. Further, the 320 ms tertiary chart 730 can schedule tasks periodically from 320 to 2560 ms.

In accordance with one aspect of the invention, each time slice (712, 722 and 732) represents an opportunity for the controller device 300 to schedule tasks. Accordingly, each primary time slice 712 in the primary chart 710 represent opportunities to put tasks at 5 ms intervals. Similarly, the secondary chart 720 and the tertiary chart 730 represent opportunities to place tasks at 40 ms or 320 ms, respectively.

FIG. 5 also shows a detailed view 770 of the primary chart 710 and the tasks processed in that primary chart. It should be noted that the detailed view 770 does not show the secondary chart 720 nor the tertiary chart 730, nor the tasks assigned to those charts (720, 730). As illustrated in FIG. 5, the processing of the primary chart 710 shown in the expanded view 770 is started by the processing of frame 758. The processing of frame 758, as shown in FIG. 5, also includes the processing of a secondary time slice 722 in the secondary chart 720. Accordingly, the processing of the secondary time slice 722 may well include the processing of tasks assigned to such secondary time slice 722. However, for purposes of illustration, it is assumed that no tasks are present in the secondary time slice 722 at frame 758.

As shown in the expanded view 770, three tasks are performed in processing of the primary chart 710. These tasks include Task A, Task B, and Task C. As shown, Task A is scheduled to execute in every primary time slice in the primary chart 710. Further, Task B is scheduled to execute in every other primary time slice 712 of the primary chart 710. Task C is also scheduled to execute in every other primary time slice 712 of the primary chart. However, the processing of Task C is off-set by the processing of Task B by one primary time slice. As a result of this off-set, the leveling of CPU loading is effected.

In accordance with one embodiment of the method of the invention, it should be appreciated that tasks may not be completed in their scheduled time period. If tasks are not completed in their scheduled time, this condition results in an overrun. There are two types of overrun conditions, including a chart overrun and a frame overrun. In order to avoid a chart overrun, the sum of the execution time for all tasks in a time slice must be less than the chart's base scheduling period. As described above, the base scheduling period for the primary chart 710 is 5 ms; the base scheduling period for the secondary chart 720 is 40 ms; in the base scheduling period for the tertiary chart 730 is 320 ms.

In contrast to a chart overrun is a frame overrun. In order to avoid a frame overrun, the execution time for all the tasks in all the charts scheduled for that particular frame must be less than the frame period.

Hereinafter, further aspects of a chart overrun and a frame overrun will be described. As described above, a chart, i.e., a primary chart, secondary chart, or tertiary chart, may form a piece of a frame. Further, the amount of time available to execute a task in a particular chart without a chart overrun is the base rate of a particular chart. Thus, if the task scheduler portion 330 is processing in the 5 ms chart, then there are 5 ms in which to execute all of the tasks in that primary chart or else there will be an overrun of the primary chart. Correspondingly, in a secondary chart 720, there are 40 ms in which to process all the tasks in the secondary chart, or else a chart overrun condition will occur. However, it should be appreciated that it is possible to overrun the frame, i.e. a frame overrun, and not overrun a chart. Illustratively, a 320 ms task, i.e., a task placed on the tertiary chart 730, may well overrun a frame, but not necessarily a chart. A chart overrun condition will only develop if such a 320 ms task is not concluded at the end of the tertiary slice in which it was scheduled.

Alternatively, a frame overrun may not occur even when processing a 320 ms task, that is, the 320 ms task may be a very fast task that is only scheduled at a slow pace. With such a fast task, the execution time of the task is low. Also, the periodic scheduling is slow. Illustratively, this condition would occur if a process was running in the background just every so often and there is not much to do. Whether, the task is simply performed every once in a while.

As described above, FIG. 2. is a block diagram showing a control systems tool 100. The control systems tool 100 includes a user interface generation portion 240. The user interface generation portion 240 allows a human user to interact with the controls systems tool 100. FIGS. 6-10 are screen shots showing exemplary user interface screens. In generating the user interface screens, the user interface generation portion 240 utilizes information received by and processed in the control systems tool 100 and in particular, in the profiler portion 200.

Specifically, the task monitor portion 210 in the profiler portion 200 inputs information from the interface portion 140 regarding the tasks performed in the controller device 300. The task monitor portion 210 then forwards the task information to the user interface generation portion 240 for display of the information. Such an arrangement allows real time observation of the tasks performed in the controller device 300. Further, the task monitor portion 210 may forward the information to the memory 130 for use at a later time.

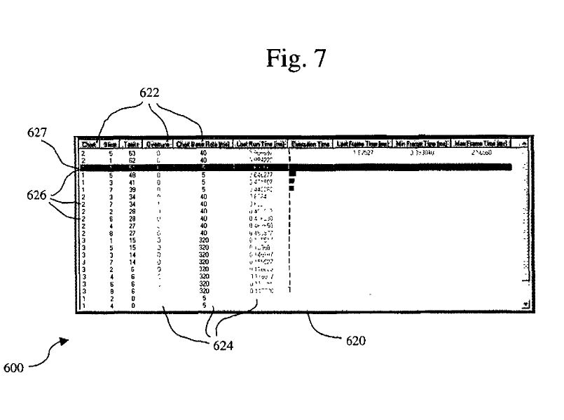

FIG. 6. is a screen shot showing an illustrative user interface screen 600 generated by the tool manager portion 110 in the control systems tool 100. The user interface screen 600 includes a tool window 610. The tool window 610 includes a menu bar 612. When a user is interested in accessing the controller load profiler features in accordance with some embodiments of the present invention, the user selects View—>Controller Load Profiler using the menu 614 as shown in FIG. 6. As a result, operational control passes from the tool manager portion 110 to the profiler portion 200 in accordance with some embodiments of the present invention. That is, the tool manager portion 110 launches the controller load profiler. The profiler portion 200, and specifically the charts/slices display portion 242 and the tasks display portion 244, in the user interface generation portion 240, generates the screen shots shown in FIGS. 7-10.

As shown in FIG. 7, the user interface screen 600, generated by the charts/slices display portion 242, displays various information regarding processing in the controller device 300. Specifically, the user interface screen 600 displays information regarding each chart, as well as each time slice contained in the respective charts. This information is displayed in a controller load window 620.

The controller load window 620 includes a plurality of headings 622 that display the chart and time slice information. Information below each heading 622 is presented in the form of columns 624. Each column 624 may contain information regarding a particular entry 626. Each entry 626 is directed to a particular chart and time slice within that chart. As shown in FIG. 7, the controller load window 620 displays information for each chart and time slice including tasks, overruns, chart base rates, last run time, execution time, last frame time, minimum frame time, and maximum frame time. As shown in FIG. 7, a user may click on a particular heading 622 to sort by that heading. The order of the sort is reversed as a result of clicking on a particular heading 622, for example.

Illustratively, the first entry 626 in the controller load window 620 is directed to chart 2, time slice 5. As shown, time slice 5 in chart 2 includes 63 tasks. No overruns are present based on the last processing of the chart. For convenience to the user, the controller loaded window 620 displays the chart base rate 40 ms. Further, the last run time was 0.908697 ms.

Under the heading of execution time, the controller load window 620 displays a bar graph representation of the execution time of the tasks performed for a particular chart and slice. The controller load window 620 also displays information regarding the last frame time, the minimum frame time and the maximum frame time.

As described above, each chart contains eight time slices. That is, each of the primary chart, secondary chart and tertiary chart contains eight time slices each. As shown in FIG. 7, the information in each “chart” column indicates a primary, secondary, or tertiary chart as shown in FIG. 5 described above. The information in the “slice” column indicates the time slice number for a particular chart. Note that the time slice values vary from one to eight, i.e., since each chart contains eight time slices. As should be appreciated from the description of FIG. 5 above, the chart base rate for each primary chart, i.e., designated by “1” in the chart column, is 5ms. Further, the chart base rate for each secondary chart is 40 ms, and the chart base rate for each tertiary chart is 320 ms.

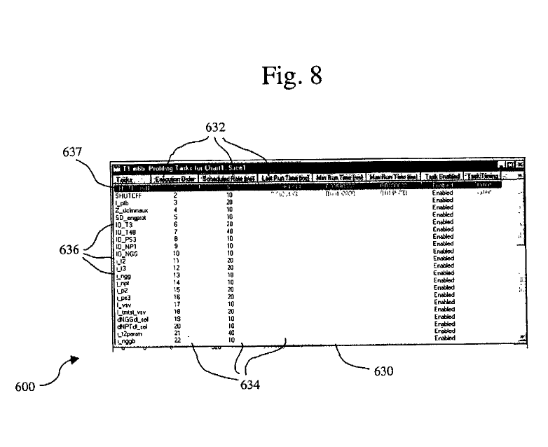

Based on a user's observation of the information contained in the controller load window 620 generated by the charts/slices display portion 242, the user may wish to view the specifics of a particular chart and time slice. For example, entry 627 for chart 1, time slice 1, displays a relatively high execution time as shown in FIG. 7. Accordingly, a user may wish to see more information regarding this particular entry 627. As a result, the user may select the entry 627 in any suitable manner such as clicking. As a result of this selection, the tasks display portion 244 generates the task window 630 as shown in FIG. 8. The task window 630 contains various profile information regarding the tasks in chart 1, time slice 1.

As shown in FIG. 8, the task window 630 displays various information under headings 632 in the form of columns 634. Also, entries 636 are displayed for respective tasks. The name of each task is displayed under the “Tasks” heading. For example, a task named “Shut Down” is shown as entry 637 in FIG. 8. From the entry 637, a user may observe that the execution order of the task “Shut Down” is first. Further, the scheduled rate of the Shut Down task is 10 ms.

The Last Run Time column displays the amount of processing time for the last time that the Shut Down task was performed. The Min Run Time displays the minimum run time of the task Shut Down since the profiling began, i.e., the quickest time duration in which the task Shut Down was processed. Similarly, the Max Run Time column displays the longest time for processing the Shut Down task. Additionally, the task window 630 includes a Task Enabled and Task Timing column. The enabled status reflects whether a particular task is enabled to send task processing information to the control systems tool 100.

In accordance with one embodiment of the method and system of the invention, a user may vary processing of tasks to optimize load leveling in the controller device 300. For example, the user may vary the chart and slice in which a particular task is located. Alternatively, the user may vary the execution order of tasks in a particular chart/slice.

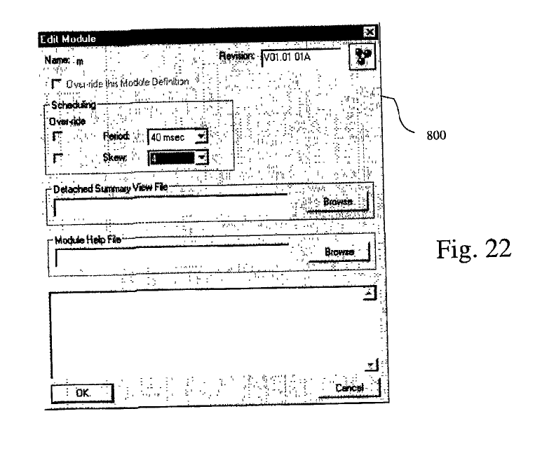

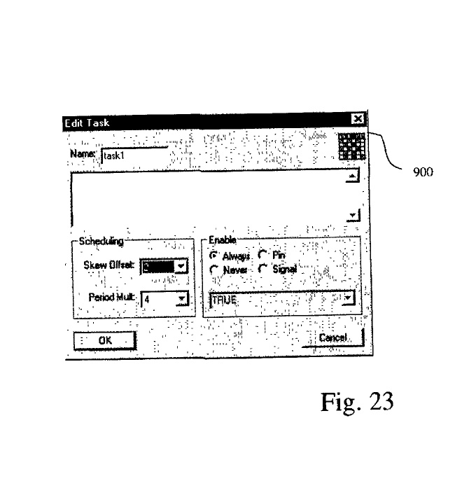

Hereinafter, further aspects of varying processing of tasks to optimize load leveling in the controller device will be described with reference to FIG. 22 and FIG. 23. In accordance with one embodiment of the method and system of the invention, FIG. 22 is a screen shot showing a module definition window 800, i.e., for a particular module. In accordance with one embodiment of the method and system of the invention, a base scheduling period is defined for all of the tasks in the module using the module definition window 800. Additionally a global skew may be specified that is applied equally to all of the tasks in the module. Accordingly, such use of the base scheduling period and global skewing allows one to load level within a chart on an entire module basis.

In further explanation of the system and method of the invention, FIG. 23 is a screen shot in accordance with one embodiment showing a task definition window 900, i.e., the definition of a particular task. As shown in the task definition window 900, a period multiplier specifies how much slower than the base scheduling period of the module the particular task is to be executed. As shown in FIG. 23, the period multiplier may be changed as is necessary or desired. The selection of a particular period multiplier may also result in skewing options. That is, as shown in FIG. 23, a particular period multiplier may result in the user being able to select skewing options that allow the user to move the particular task within the time slices of the chart. This capability allows a user to load level within a chart on a task basis.

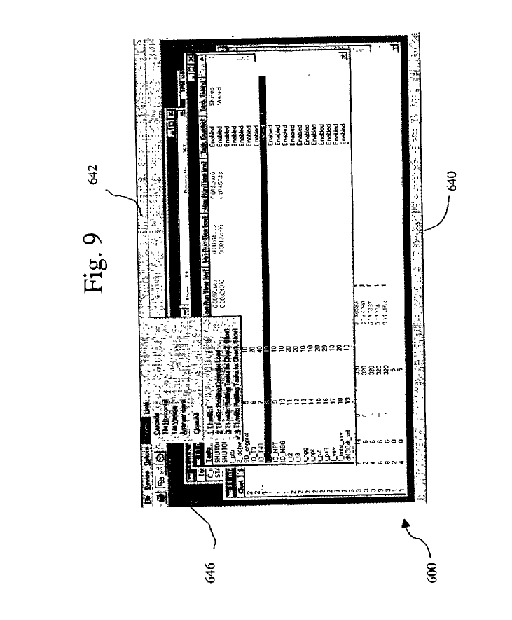

Hereinafter, further aspects of the invention will be described with reference to FIG. 9. FIG. 9 illustrates further aspects in accordance with some embodiments of the method and system of the invention. As shown in FIG. 9, the user interface screen 600 is a tool window 640. From the tool window 640 a user is able to distinguish which windows are open in the system based on the items in a drop-down menu 646. Specifically, by selecting Window in the menu bar 642, the drop-down menu 646 displays the titles, and therefore the tasks and charts, that are being profiled. If a user wishes to view a particular window in the menu 646, the user simply selects that desired window. It should be appreciated that the user interface generation portion 240, in response, displays the requested window.

In accordance with one embodiment of the method and system of the invention, the profiler portion 200 generates configuration information known as PCODE for a particular task that is desired to be profiled. Once the user has selected the controller load profiler enable checkbox, the control systems tool 100 will add the PCODE as shown in the record definition set forth below. The record definition defines what is used to generate the byte codes that are downloaded to the controller device 300 in order to tell the controller device 300 where to store chart and frame profiling information in accordance with one embodiment of the invention. Similar information is added to existing task definition records as each task is enabled for profiling.

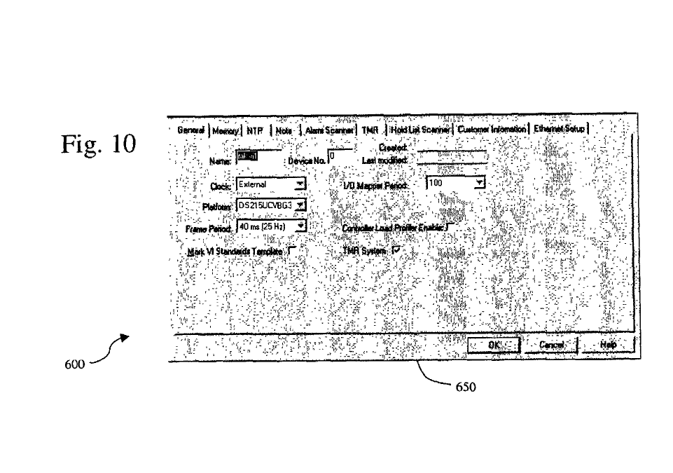

In accordance with some embodiments of the method and system of the invention, the control systems tool 100 conveys to the controller device 300 information regarding the manner in which the profiling of the processed task is performed. Illustratively, the profiler portion 200 in the control systems tool 100 generates this information in the form of a Pcode, i.e., a portable or pseudo code. In order to generate the Pcode that is downloaded to the controller with the controller load profiling enabled, the user first selects profiling in the device dialog 650 as shown in FIG. 10.

Once the user has selected the Controller Load Profiler Enable checkbox in the device dialogue 650, profiler portion 200 will add the Pcode. In accordance with one embodiment of the method and system of the invention the following record definition may be utilized:

| | | |
|---|---|---|
| [t1] | | |
| struct | pmon_record{ | |
| | unsigned short | record_type {PMON_REC = 49}; |
| | unsigned long | record_number; |
| | unsigned long | byte_count; |
| | unsigned long | reserved[8]; |
| | VAR_TOKEN | tick_resolution; // s.p. float for the number of uSecs per tick |
| | ARRAY_VAR_TOKEN slices[24]; | // array of 24 long integers |
| | ARRAY_VAR_TOKEN overruns[24]; | // array of 24 short integers |
| | VAR_TOKEN flame_time[3]; | // array of 3 long ints for turbine frame time |
| }; | | |

RECORD_TYPE

The record structure identifier.

RECORD_NUMBER

The record instance number.

BYTE_COUNT

The number of bytes in the entire record.

RESERVED

Space reserved for future enhancements.

TICK_RESOLUTION

A single-precision floating point variable that the controller will populate with the resolution of the time ticks in micro-Seconds (uS) per tick. The Toolbox must use this value to convert the load information into engineering units for the user.

SLICES

An array of long integers used to store the load information for each of the eight time slices in each of the three scheduling charts. The information is distributed as follows:

| | | |
|---|---|---|
| [t2] | slices[0-7] | slices 1-8 of 5 mS chart |
| | slices[8-15] | slices 1-8 of 40 mS chart |
| | slices[16-23] | slices 1-8 of 320 mS chart |

The load information for the 40 and 320 mS charts will include any additional time due to pre-emption by higher processes (other foreground charts or I/O drivers).

OVERRUNS

An array of short integers used to store the cumulative number of overruns experienced by each of the eight time slices in each of the three scheduling charts. The information is distributed as follows:

| | | |
|---|---|---|
| [t3] | overruns[0-7] | slices 1-8 of 5 mS chart |
| | overruns[8-15] | slices 1-8 of 40 mS chart |
| | overruns[16-23] | slices 1-8 of 320 mS chart |

The overrun information for the 40 and 320 mS charts will include any additional time due to pre-emption by higher processes (other foreground charts or I/O drivers). An overrun is defined to occur whenever the time required to execute all of the tasks specified for a particular time slice exceeds the time allotted for that slice (the based scheduling period for the chart).

FRAME_TIME[3]

An array of long integers that contains the execution time for an entire frame. A frame is defined to be the aggregate of all of the tasks specified to execute in one of the 512 possible scheduling slices created by transforming the three treed scheduling charts into a single flat chart.

| | | |
|---|---|---|
| [t4] | frame_time[0] | current frame time ticks |
| | frame_time[1] | minimum frame time ticks |
| | frame_time[2] | maximum frame time ticks |

It should be appreciated that the method of the invention may be implemented utilizing suitable code as is desired. For example, tokens may be utilized. The use of tokens may be characterized as the use of a continuously repeating frame, i.e., the token, that is transmitted onto a communications network by a particular controlling computer. The controlling computer may send a message by waiting for and then filling an empty token, which may be filled with destination information, as well as a portion or all of the message. That is, programming code may be used by which the control systems tool 100 assigns the correct tokens to the signals that will be used to monitor the controller signal space while profiling.

It should be appreciated that the above exemplary record is for purposes of illustration only, and further, that a variety of code may be used to practice the system and method of the invention as is necessary or desired. Accordingly, wide variations of the exemplary record may be utilized in accordance with some embodiments of the method and system of the invention.

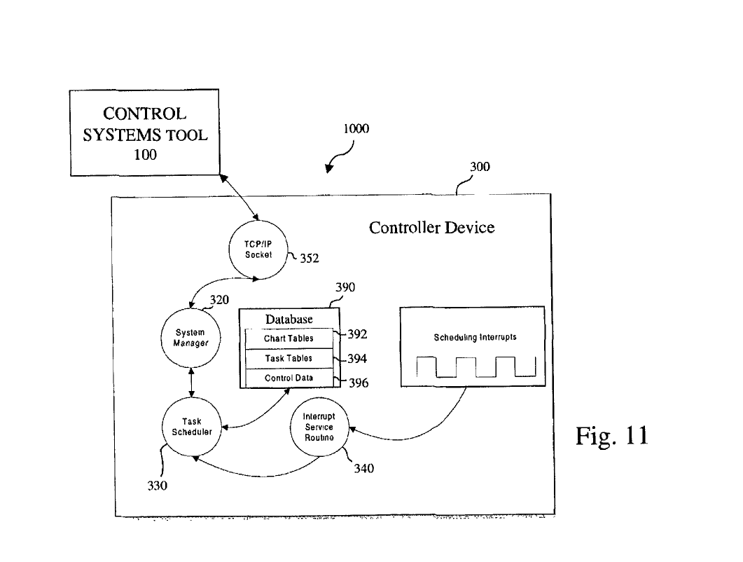

FIG. 11 is a diagram showing further aspects of the network system 1000, and specifically, the controller device 300. As shown in FIG. 1, the network system 1000 includes a control systems tool 100 and the controller device 300. As described above with reference to FIGS. 1-3, the control systems tool 100 and the controller device 300 may communicate in any suitable manner.

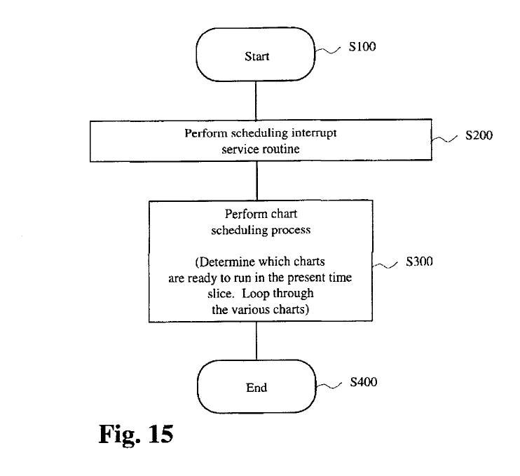

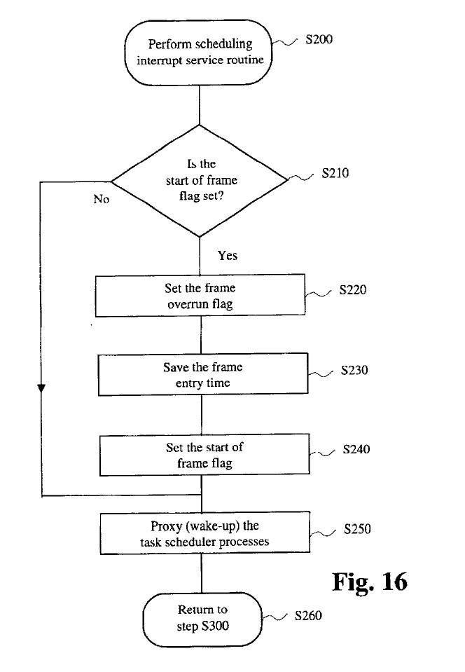

The controller device 300 also includes a system manager 320, a task scheduler portion 330, and an interrupt service portion 340. The system manager 320 controls various functions to maintain operation of the controller device 300. For example, the system manager 320 may control back-up and recovery operations, virus protection, and network communications as well as the overall operation of the controller device 300. The system manager 320 interacts with the task scheduler portion 330, which performs scheduling of tasks performed in the controller device 300. The operations performed by the task scheduler portion 330 are described in conjunction with FIGS. 15 and 16 below. The interrupt service portion 340 controls the interruption of the tasks. The operations of the interrupt service portion 340 are described in conjunction with FIGS. 15 and 17-21 below.

As shown in FIG. 11, the control systems tool 100 and the controller device 300 communicate over an Ethernet 10 utilizing a TCP-IP protocol. Specifically, the controller device 300 utilizes TCP-IP socket 352. The TCP-IP socket 352 may be in the form of a software object that connects the controller device 300 to the TCP-IP network protocol utilized on the Ethernet 10. Accordingly, the system manager 320 can send and receive messages utilizing the TCP-IP protocol by opening the TCP-IP socket 352 and reading and writing data to and from the TCP-IP socket.

As described above, the task scheduler portion 330 schedules tasks performed by the controller device 300. In performance of these tasks, the task scheduler portion 330 uses various operating parameters set forth in database 390. The database 390 includes a chart tables portion 392, a task tables portion 394, and a control data portion 396. These data structures are utilized by the task scheduler portion 330 to perform the scheduling of tasks.

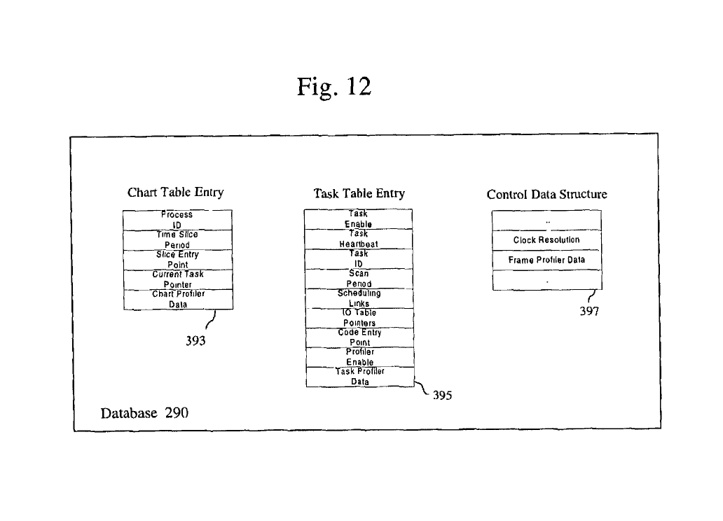

FIG. 12 shows further aspects of the data structures utilized in the database 390. Specifically, FIG. 12 shows a chart table entry 393 that is contained in the chart tables portion 392. As shown in FIG. 12, the chart table entry 393 contains various parameters associated with a particular chart. The chart table entry 393 includes a process ID, a time slice period, a time slice entry point, current task pointer, and chart profiler data.

FIG. 12 also shows an illustrative data structure contained in the task table portion 394. The task table entry 395 shown in FIG. 12 includes various parameters associated with a particular task. Specifically, for example, the task table entry 395 includes a task enable parameter, a task heartbeat, task ID, scan period, scheduling links, IO table pointers, a “code entry point” parameter, a “profiler enable” parameter and “task profiler data” parameter.

Additionally, FIG. 12 shows a control data structure 397 contained in the control data portion 396. The control data structure 397 contains various parameters utilized by the task scheduler portion 330. As illustratively shown in FIG. 12, the control data structure 397 includes clock resolution and frame profiler data. However, it should be appreciated that various other operating parameters may be contained in the control data structure 397, as is necessary or desired.

As shown in FIG. 11, the controller device 300 also includes the interrupt service portion 340. The interrupt service portion 340 works in conjunction with the task scheduler portion 330 to control the start and stop of tasks. Specifically, in accordance with one embodiment of the method and system of the invention, the task scheduler portion 330 commands the interrupt service portion 340 to interrupt a task, i.e. such that a task with a higher priority may be executed.

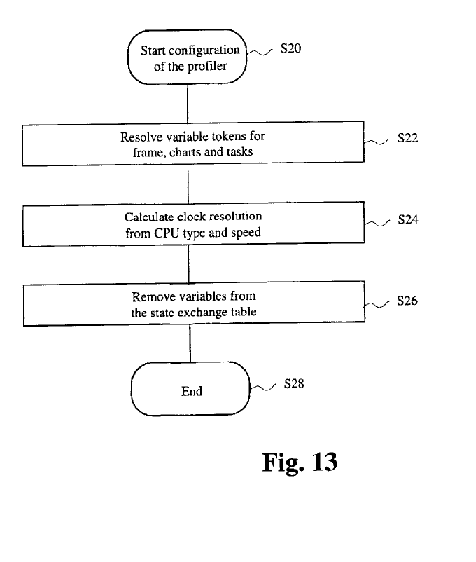

FIGS. 13-21 are flow charts illustrating aspects of implementation in accordance with one embodiment of the invention. FIGS. 13-21 will hereinafter be described in conjunction with the network system shown in FIGS. 1-3 and FIG. 11. However, it should be appreciated that the processes illustrated in FIGS. 13-21 are not limited to implementation utilizing the network system of FIGS. 1-3 and FIG. 11. Rather, one skilled in the art should appreciate that a variety of operating systems may be utilized in accordance with some embodiments of the method and system of the invention.

FIG. 13 is a flow chart showing aspects of configuration of the profiler portion 200 in the control systems tool 100. The profiler portion 200 is configured prior to beginning profiling operations. As shown in FIG. 13, the process to configure the profiler portion 200 starts in step S20. Then, the process passes to step S22. In step S22, the profiler portion 200 resolves the variable tokens for frame, charts, and tasks. Then, in step S24, the profiler portion 200 calculates the clock resolution. The clock resolution may be calculated utilizing the CPU type and speed. Then, the process passes to step S26. In step S26, the profiler portion 200 removes the variables from the state exchange table. This step is particular to voted controllers as profiling information should be collected per controller and not voted, as other state variables might be. In step S28, the configuration of the profiler portion 200 is completed. As a result, the connection of the profiler portion 200 to the controller device 300 must next be established.

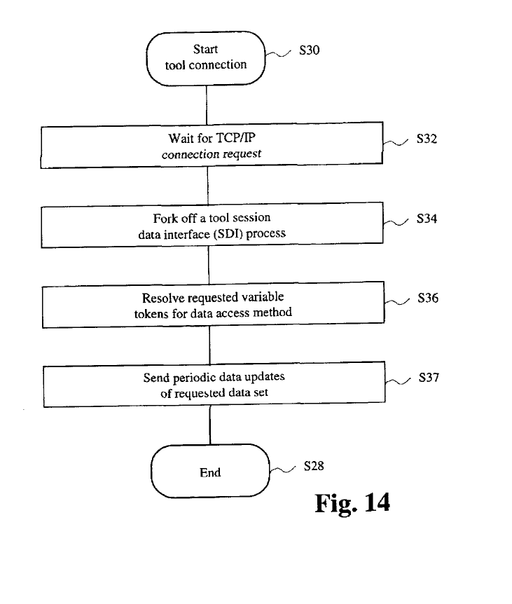

FIG. 14 is a flow chart illustrating aspects of establishing a connection between the control systems tool 100 and the controller device 300. As shown in FIG. 14, the tool connection is initiated in step S30. Then, in step S32, the control systems tool 100 waits for a TCP-IP connection request. Once the connection is established, the process passes to step S34. In step S34, the tool 100 forks off a tool session data interface (SDI) process. Then, the process passes to step S36. In step S36, the control systems tool 100 resolves the requested variable tokens for data access method. After step S36, the process passes to step S37.

In step S37 as shown in FIG. 14, the controller device 300 sends periodic data updates of requested data sets to the control systems tool 100. Then, in step S28, the process ends. Termination of the process in step S28 may result from active termination by a user or a disconnect between the control systems 100 and the controller device 300.

FIG. 15 is a high level flow chart showing aspects of scheduling in accordance with one embodiment of the method and system of the invention. As shown in FIG. 15, the process starts in step S100. Then, the process passes to step S200. In step S200, the interrupt service portion 340 performs the scheduling interrupt service routine. Then the process passes to step S300. In step S300 task scheduler portion 330 performs the chart scheduling process. That is, in step S300, the process determines which charts are ready to run in the current time slice. Further, the process loops through the primary chart, secondary chart, and tertiary chart for tasks that are ready to run. Further details of step S300 are described below. After step S300, the process passes to S400. In step S400, the process ends.

FIG. 16 is a flow chart showing in further detail the scheduling interrupt service routine step S200 of FIG. 15. Specifically, FIG. 16 illustrates the process implemented by the interrupt service portion 340 shown in FIG. 11. As shown in FIG. 16, the process starts in step S200. Then, the process passes to step S210. In step S210, the interrupt service portion 340 determines whether the start of a frame flag is set. If NO, then the task scheduler portion 330 immediately moves to initiate the task schedule processes. Specifically, as shown in FIG. 16, the task scheduler portion 330 proxies, or wakes up, the task scheduler processes.

Alternatively, the interrupt service portion 340 may determine in step S210 that the start of the frame flag is set, i.e., YES in step S210. In that case, the interrupt service portion 340 sets the frame overrun flag in step S220. Then, in step S230, the interrupt service portion 340 sets the frame entry time. Further, in step S240, the interrupt service portion 340 sets the start of the frame flag. Then, the interrupt service portion 340 proxies or wakes up the task scheduler processes, as described above, in step S250.

After step S250, the process passes to step S260. In step S260, the process returns to step S300 in FIG. 15 in order to perform the chart scheduling process.

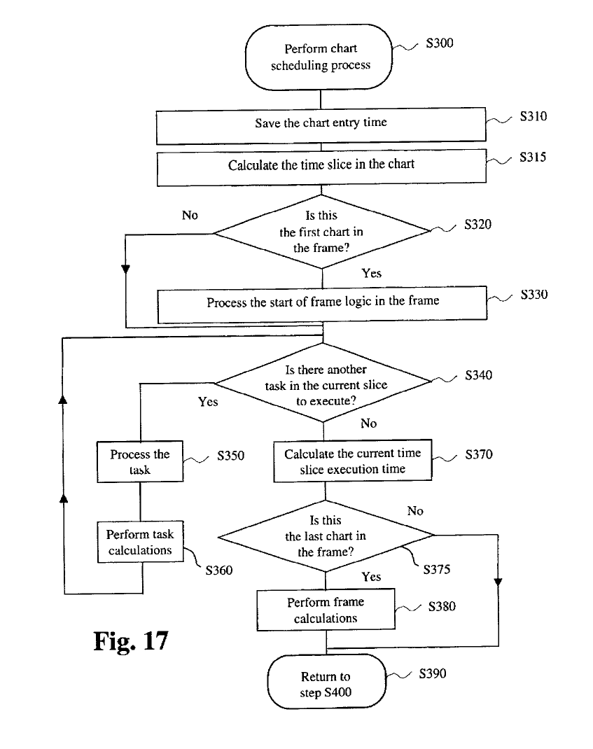

FIG. 17 is a flow chart illustrating an implementation of the processes performed by the task scheduler portion 330 to perform the chart scheduling process. As shown in FIG. 17, the process starts in step S300 in which the task scheduler portion 330 starts scheduling the various task in the chart being processed. Then, the process passes to step S310 in which the task scheduler portion 330 saves the chart entry time. By saving the chart entry time, the task scheduler portion 330 will later be able to determine the total processing time of the chart.

After step S310 as shown in FIG. 17, the process passes to step S315. In step S315, the task scheduler portion 330 calculates the time slice in the chart. Then, the task scheduler portion 330 determines whether the present chart is the first chart in the frame in step S320. If the task scheduler portion 330 determines that the present chart is the first chart in the frame, then the process passes to step S330. In step S330, the task scheduler portion 330 processes the start of frame logic prior to executing the first task, i.e., any task.

Alternatively, the task scheduler portion 330 may determine that the present chart is not the first chart in the frame. As a result, the process passes directly to step S340. In step S340, the task scheduler portion 330 determines whether there is another task in the current time slice to execute. If there is another task in the current time slice to execute, then the task scheduler portion 330 proceeds to process that task, as represented in step S350 in FIG. 17. Once the task is processed, then the task scheduler portion 330 performs task calculations in conjunction with the processing of that task as shown in step S360. The result of these task calculations are communicated to the profiler portion 200 and displayed to the user as shown in FIG. 8, for example. After step S360, the task scheduler portion 330 returns to step S340.

Eventually, the task scheduler portion 330 will determine that there is not another task in the current time slice to execute. That is, the determination in step S340 will be NO. Then, the process passes to step S370. In step S370, the task scheduler portion 330 calculates the current time slice execution time. Then, in step S375, the task scheduler portion 330 determines whether the present chart is the last chart in the frame. If YES, i.e., the present chart is the last chart in the frame, then the process passes to step S380, at which time the task scheduler portion 330 performs frame calculations since the frame is completed. After step S380, the process passes to step S390.

Alternatively, the task scheduler portion 330 may determine that the present chart is not the last chart in the frame. As a result, the process passes directly from step S375 to step S390. In step S390, the process returns to step S400, as shown in FIG. 15. In step S400, the process ends as to that frame, or in other words, proceeds to the next frame.

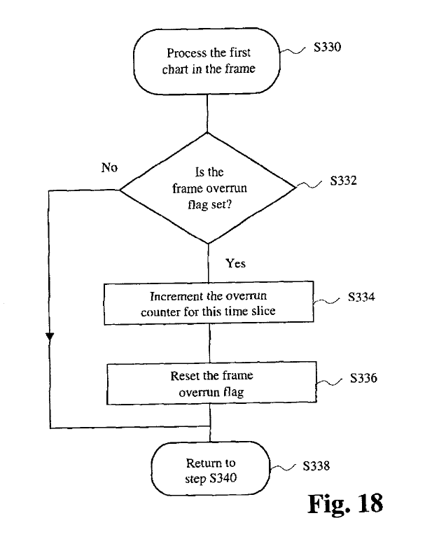

FIG. 18 shows in further detail the “process the first chart in the frame” step S330 of FIG. 17. As shown in FIG. 18, the process starts in step S330. Then, the process passes to step S332. In step S332, the task scheduler portion 330 determines whether a frame overrun flag has been set. If the task scheduler portion 330 determines that a frame overrun flag has been set, then the process passes to step S334. In step S334, the task scheduler portion 330 increments the overrun counter for the present time slice being processed. Then, the process passes to step S336. In step S336, the task scheduler portion 330 resets the frame overrun flag. Then, the process passes to step S338.

Alternatively, the task scheduler portion 330 may determine in step S332 that the frame overrun flag is not set. As a result, the process passes directly from step S332 to step S338. In step S338, the process implemented by the task scheduler portion 330 returns to step S340 of FIG. 17.

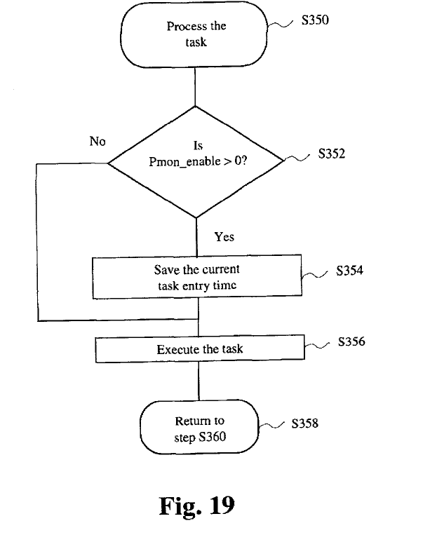

FIG. 19 is a flow chart showing the “process the task” step of FIG. 17 in further detail. As shown in FIG. 19, the process starts in step S350. Then, the process passes to step S352. In step S352, the task scheduler portion 330 performs a determination regarding the variable Pmon_enable. This determination dictates whether profiling information is collected for the particular task being processed. Specifically, the task scheduler portion 330 determines whether the value of the variable Pmon_enable is greater than zero. If the task scheduler portion 330 determines that the variable Pmon_enable is greater than zero, then the process passes to step S354. In step S354, the task scheduler portion 330 saves the current task entry time. Then, the process passes to step S356 in which the task scheduler portion 330 executes the task.

Alternatively, the task scheduler portion 330 may determine that the value of the variable Pmon_enable is not greater than zero. As a result, the process passes directly from step S352 to step S356 as shown in FIG. 19, i.e., since profiling information for the particular task is not collected.

As described above, in step S356, the task scheduler portion 330 executes the task. After step S356, the process passes to step S358. In step S358, the process returns to step S360 as shown in FIG. 17.

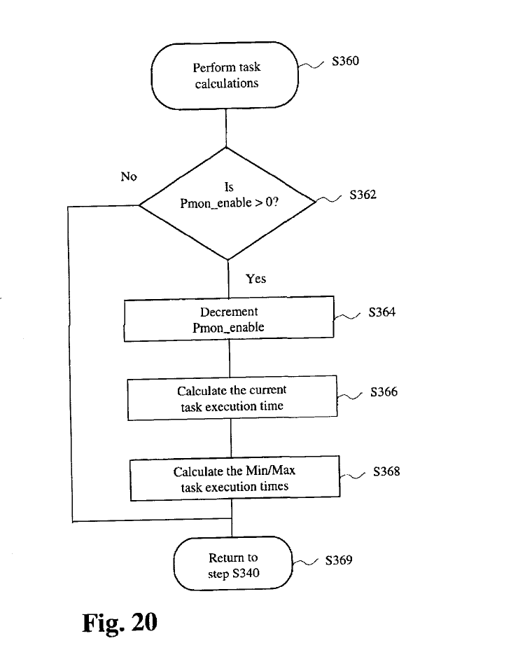

FIG. 20 illustrates the performance of task calculations by the task scheduler portion 330. As shown in FIG. 20, the process starts in step S360. Then, the process passes to step S362 in which the task scheduler portion 330 describes whether the value of the variable Pmon_enable is greater than zero, in a manner similar to that described in conjunction with FIG. 19. If YES, then the process passes to step S364. In step S364, the task scheduler portion 330 decrements the value of the variable Pmon_enable. Then, in step S366, the task scheduler portion 330 calculates the current task execution time. After step S366, the process passes to step S368. In step S368, the task scheduler portion 330 calculates the min/max task execution time. After step S368, the task scheduler portion 330 passes to step S369.

Alternatively, the task scheduler portion 330 may determine in step S362 that the value of the variable Pmon_enable is not greater than zero. As a result, the process passes directly from step S362 to step S369. In step S369, the process returns to step S340 as shown in FIG. 17. As described above, in step S340, the task scheduler portion 330 determines whether there is another task in the current time slice to execute. If there are any, the process proceeds as described above.

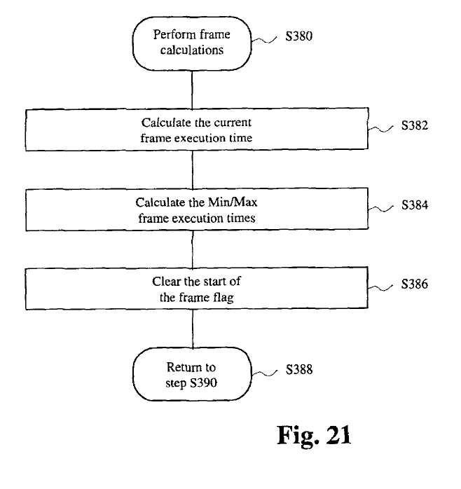

FIG. 21 is a flow chart showing the frame calculations step S380 of FIG. 17 in further detail. As shown in FIG. 21, the process of FIG. 21 starts in step S380. Thereafter, the process passes to step S382. In step S382, the task scheduler portion 330 calculates the current frame execution time. Then, in step S384, the task scheduler portion 330 calculates the min/max frame execution times.

After step S384, the process passes to step S386. In step S386, the task scheduler portion 330 clears the start of the frame flag in order to indicate the completion of a frame. After step S386, the process passes to step S388. In step S388, the process returns to step S390 as shown in FIG. 17.

As described above, an embodiment of the system of the invention as shown in FIGS. 1-3, 11 and 12 is in the form of a computer or computer system. As used herein, the term “computer system” is to be understood to include at least one processor utilizing a memory or memories. The memory stores at least portions of an executable program code at one time or another during operation of the processor. Additionally, the processor executes various instructions included in that executable program code. An executable program code means a program in machine language that is able to run in a particular computer system environment to perform a particular task. The executable program code processes data in response to commands by a user. As used herein, it will be appreciated that the term “executable program code” and term “software” mean substantially the same thing for the purposes of the description.

Further, it is to be appreciated that to practice the system and method of the invention, it is not necessary that the processor in each of the control systems tool 100 and the controller device 300, for example, and/or the memory be physically located in the same place. That is, it should be appreciated that each of the respective processor and the memory, or portion thereof, may be located in geographically distinct locations and connected so as to communicate in any suitable manner, such as over a network, for example. Additionally, it should be appreciated that each of the processor and/or the memory, in each of the respective operating components, may be composed of different physical pieces of equipment. Accordingly, it is not necessary that each processor be one single piece of equipment in one location and that the memory be another single piece of equipment in another location. That is, it is contemplated that a single processor may be two pieces of equipment in two different physical locations. The two distinct pieces of equipment may be connected in any suitable manner. Additionally, the memory may include two or more portions of memory in two or more physical locations. Further, the memory could include or utilize memory stores from the Internet, Intranet, Extranet, LAN or some other source or over some other network, as may be necessary or desired.

Various embodiments of the method and system of the invention have been described above in the operating environment of the control systems tool 100 and the controller device 300. However, it should be appreciated that the aspects of the invention relating to the monitoring and control of the task load of a processor are not limited to the control systems tool 100 and controller device 300 environment. Rather, the techniques for monitoring and control of the task load of a processor of the invention, as described above, may be used in other operating environments.

As described above, the invention may illustratively be embodied in the form of a computer or computer operating system. It is to be appreciated that the software that enables the computer operating system to perform the operations described above may be supplied on any of a wide variety of data holding media. Further, it should be appreciated that the implementation and operation of the invention may be in the form of computer code written in any suitable programming language, which provides instructions to the computer or computers.

It should further be appreciated that the software code or programming language that is utilized in a computer system to perform the above described invention may be provided in any of a wide variety of forms. Illustratively, the software may be provided in the form of machine language, assembly code, object code, or source language, as well as in other forms. Further, the software may be in the form of compressed or encrypted data utilizing an encryption algorithm.

Additionally, it should be appreciated that the particular medium utilized may take on any of a variety of physical forms. Illustratively, the medium may be in the form of a compact disk, a DVD, an integrated circuit, a hard disk, a floppy diskette, a magnetic tape, a RAM, a ROM, or a remote transmission, as well as any other medium or source of information that may be read by a computer or other operating system.

Accordingly, the software used in practice of the invention may be provided in the form of a hard disk or be transmitted in some form using a direct telephone connection, the Internet, an Intranet, or a satellite transmission, for example. Further, the programming language enabling the system and method of the invention as described above may be utilized on all of the foregoing types of medium and any other medium by which software or executable program code may be communicated to and utilized by a computer or other operating system.

As described herein, the system and method of the invention may utilize an application program, a collection of separate application programs, a module of a program that is designed to handle, or a portion of a module of a program, for example. As noted above, it should be appreciated that the computer language used in the system and method of the invention may be any of a wide variety of programming languages. Further, it is not necessary that a single programming language be utilized in conjunction with the operation of the system and method of the invention. Rather, any number of different programming languages may be utilized as is necessary or desirable.

As described above, in the system and method of the invention, a variety of user interfaces are utilized. A user interface may be in the form of a dialogue screen for example. As used herein, a user interface includes any software, hardware or combination of hardware and software used in an operating system that allows a user to interact with the operating system. A user interface may include any of a touch screen, keyboard, mouse, voice reader, voice recognizer, dialogue screen, menu box, a list, a checkbox, a toggle switch, a pushbutton or any other object that allows a user to receive information regarding the operation of the program and/or provide the operating system with information. Accordingly, the user interface is any device that provides communication between a user and a computer. The information provided by the user to the computer through the user interface may be in the form of a command, a selection or data, or other input, for example.

A user interface is utilized by an operating system running an application program to process data for a user. As should be appreciated, a user interface is typically used by a computer for interacting with a user either to convey information or receive information. However, it should be appreciated that in accordance with some embodiments of the system and method of the invention, it is not necessary that a human user actually interact with a user interface generated by the operating system of the invention. Rather, it is contemplated that the user interface of the invention interact, i.e., convey and receive information, in communication with another operating system or computer, rather than a human user. Further, it is contemplated that the user interfaces utilized in the system and method of the invention may interact partially with another operating system while also interacting partially with a human user.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the claims and their legal equivalents.

What is claimed is:

1. A method of monitoring and scheduling tasks in an operating system, the method comprising the steps of:
obtaining task information relating to tasks processed in the operating system;
generating a user interface based on the obtained task information, the user interface displaying parameters related to the task information;
determining loading of the operating system based on the user interface; and
adjusting the scheduling of tasks based on the loading of the operating system.

2. The method according to claim 1, wherein the operating system includes a tool and a controller, and the tasks are processed in the controller and the user interface is generated by the tool.

3. The method according to claim 1, the method further including the step of representing processing time using a system of charts.

4. The method according to claim 3, wherein the system of charts includes a plurality of charts.

5. The method according to claim 4, wherein the plurality of charts includes:
a primary chart having eight primary time slices, each of the primary time slices representing a time duration;
a secondary chart having eight secondary time slices, each of the secondary time slices representing a time duration eight times as long as the time duration represented by each primary time slice; and
a tertiary chart having eight tertiary time slices, each of the tertiary time slices representing a time duration eight times as long as the time duration represented by each secondary time slice.

6. The method according to claim 5, wherein the step of adjusting the scheduling of tasks includes moving a task from one of the primary chart, secondary chart or tertiary chart to another of the primary chart, secondary chart, or tertiary chart.

7. The method according to claim 5, wherein the step of adjusting the scheduling of tasks includes moving a task from one set of time slices of the primary chart, secondary chart or tertiary chart to another set of time slices of the same primary chart, secondary chart, or tertiary chart.

8. The method according to claim 7, wherein the moving a task from one set of time slices of the primary chart, secondary chart or tertiary chart to another set of time slices of the primary chart, secondary chart, or tertiary chart is performed using skewing of the task.

9. The method according to claim 5, wherein the user interface generates profiles of each of the plurality of charts for each of the eight time slices in each respective chart.

10. The method according to claim 9, wherein the profile for each of the eight time slices in each chart includes at least one selected from the group consisting of number of tasks in the time slice, overruns, and execution time for each chart.

11. The method according to claim 10, wherein the method further includes the steps of:
selecting a time slice within one of the plurality of charts; and
generating a detailed profile of that selected time slice.

12. The method according to claim 11, wherein the detailed profile includes at least one selected from the group consisting of execution order of a task, scheduled rate, last run time, minimum run time and maximum run time.

13. A method of monitoring and scheduling tasks in an operating system, the method comprising the steps of:
obtaining task information relating to tasks processed in the operating system;
generating a user interface based on the obtained task information, the user interface displaying parameters related to the task information, the task information based on a system of charts, the system of charts including a plurality of charts;
determining loading of the operating system based on the user interface; and
adjusting the scheduling of tasks based on the loading of the operating system, wherein the operating system includes a tool and a controller, and the tasks are processed in the controller and the user interface is generated by the tool.

14. The method according to claim 13, wherein the plurality of charts includes:
a primary chart having eight primary time slices, each of the primary time slices representing a time duration; and
a secondary chart having a predetermined number of secondary time slices, each of the secondary time slices representing a time duration the predetermined number times as long as the time duration represented by each primary time slice.

15. The method according to claim 14, wherein the step of adjusting the scheduling of tasks includes moving a task from one of the primary chart or secondary chart to another of the primary chart or secondary chart.

16. The method according to claim 14, wherein the step of adjusting the scheduling of tasks includes moving a task from one set of time slices of the primary chart or secondary chart to another set of time slices of the same primary chart or secondary chart using skewing of the task.

17. The method according to claim 14, wherein the user interface generates profiles of each of the plurality of charts for each of the time slices in each respective chart, the profile for each of the time slices in each chart includes at least one selected from the group consisting of number of tasks in the time slice, overruns, and execution time for each chart, and wherein the method further includes the steps of:
selecting a time slice within one of the plurality of charts; and
generating a detailed profile of that selected time slice; and
wherein the detailed profile includes at least one selected from the group consisting of execution order of a task, scheduled rate, last run time, minimum run time and maximum run time.

18. A system for monitoring and controlling the scheduling of tasks in a task portion, the system comprising:
a profiler portion, the profiler portion including:
a task monitor portion that obtains task information from the task portion;
a user interface generation portion that represents the task information to a user on a display; and
a task adjustment portion that adjusts parameters of tasks, based on the input of the user, in the task portion to control processing loading of the task portion.

19. The system according to claim 18, wherein the user interface generation portion includes:
a charts/slices display portion for generating information on the display relating to charts and slices and the loading of tasks on the charts and slices; and
a tasks display portion for generating information on the display relating to parameters of tasks.

20. The system according to claim 18, wherein the task portion is in a controller device, and the profiler portion is in a control systems tool.

21. The system according to claim 20, wherein the controller device and the control systems tool are connected to each other over a communications network.

22. The system according to claim 21, wherein the controller device includes a controller countdown timer portion, and the control systems tool includes a tool replenishment timer portion, the tool replenishment timer portion replenishing the controller countdown timer portion so long as the controller device and the control systems tool are in communication, and wherein the controller device sends task information to the control systems tool so long as the controller countdown timer portion is not expired.

23. The system according to claim 18, wherein the user interface generation portion, based on information from the task monitor portion, represents processing time using a system of charts, the system of charts including a plurality of charts.

24. The system according to claim 23, wherein the plurality of charts includes a primary chart having primary time slices and a secondary chart having secondary time slices, wherein tasks on the primary chart receive priority over tasks on the secondary chart, and wherein the user interface generation portion displays task information based on the primary chart and secondary chart.

25. The system according to claim 24, wherein the plurality of charts further includes a tertiary chart having tertiary time slices, wherein tasks on the secondary chart receive priority over tasks on the tertiary chart, and wherein the user interface generation portion displays task information based on the primary chart, secondary chart and tertiary chart.

26. The system according to claim 25, wherein each of the primary time slices represents a time duration, each of the secondary time slices represents a time duration eight times as long as the time duration represented by each primary time slice, and each of the tertiary time slices representing a time duration eight times as long as the time duration represented by each secondary time slice.

27. The system according to claim 25, wherein the task adjustment portion adjusts the loading of a task by moving a task from one of the primary chart, secondary chart or tertiary chart to another of the primary chart, secondary chart, or tertiary chart.

28. The system according to claim 25, wherein the task adjustment portion adjusts the loading of a task by moving a task from one set of time slices of the primary chart, secondary chart or tertiary chart to another set of time slices of the same primary chart, secondary chart, or tertiary chart.

29. A system for monitoring and controlling the scheduling of tasks in a task portion, the system comprising:
a profiler portion, the profiler portion including:
a task monitor portion that obtains task information from the task portion;
a user interface generation portion that represents the task information to a user on a display, the user interface generation portion, based on information from the task monitor portion representing processing time using a system of charts, the system of charts including a plurality of charts, the user interface generation portion including:
a charts/slices display portion for generating information on the display relating to charts and slices and the loading of tasks on the charts and slices; and
a tasks display portion for generating information on the display relating to parameters of tasks; and
a task adjustment portion that adjusts parameters of tasks, based on the input of the user, in the task portion to control processing loading of the task portion; and
wherein the task portion is a controller device, and the profiler portion is in a control systems tool, the controller device and the control systems tool being connected to each other over a communications network.

30. The system according to claim 29, wherein the controller device includes a controller countdown timer portion, and the control systems tool includes a tool replenishment timer portion, the tool replenishment timer portion replenishing the controller countdown timer portion so long as the controller device and the control systems tool are in communication, and wherein the controller device sends task information to the control systems tool so long as the controller countdown timer portion is not expired.

31. The system according to claim 29, wherein the plurality of charts includes a primary chart having primary time slices and a secondary chart having secondary time slices, wherein tasks on the primary chart receive priority over tasks on the secondary chart, and wherein the user interface generation portion displays task information based on the primary chart and secondary chart.

32. The system according to claim 31, wherein the plurality of charts further includes a tertiary chart having tertiary time slices, wherein tasks on the secondary chart receive priority over tasks on the tertiary chart, and wherein the user interface generation portion displays task information based on the primary chart, secondary chart and tertiary chart.

33. The system according to claim 32, wherein the task adjustment portion adjusts the loading of a task by moving a task from one of the primary chart, secondary chart or tertiary chart to another of the primary chart, secondary chart, or tertiary chart.

34. The system according to claim 32, wherein the task adjustment portion adjusts the loading of a task by moving a task from one set of time slices of the primary chart, secondary chart or tertiary chart to another set of time slices of the same primary chart, secondary chart, or tertiary chart.

35. A tool system for monitoring and scheduling tasks in an operating system, the tool system comprising:
means for obtaining task information relating to tasks processed in the operating system;
means for generating a user interface based on the obtained task information, the user interface displaying parameters related to the task information;
means for determining loading of the operating system based on the user interface; and
means for adjusting the scheduling of tasks based on the loading of the operating system.

36. The tool system according to claim 35, wherein the means for generating a user interface represents processing time in the operating system, using a system of charts, the system of charts includes a plurality of charts that include:
a primary chart having eight primary time slices, each of the primary time slices representing a time duration;
a secondary chart having eight secondary time slices, each of the secondary time slices representing a time duration eight times as long as the time duration represented by each primary time slice; and
a tertiary chart having eight tertiary time slices, each of the tertiary time slices representing a time duration eight times as long as the time duration represented by each secondary time slice.

37. A tool system for monitoring and scheduling tasks in an operating system, the tool system comprising:
means for obtaining task information relating to tasks processed in the operating system;
means for generating a user interface based on the obtained task information, the user interface displaying parameters related to the task information, the task information based on a system of charts, the system of charts including a plurality of charts;
means for determining loading of the operating system based on the user interface; and
means for adjusting the scheduling of tasks based on the loading of the operating system, wherein the operating system is a controller.
